(19) United States
(12) Patent Application Publication
(10) Pub. No.: US 2019/0156544 A1
(43) Pub. Date: May 23, 2019

(54) DATA AUGMENTATION APPARATUS, DATA AUGMENTATION METHOD, AND NON-TRANSITORY COMPUTER READABLE MEDIUM

(71) Applicant: Preferred Networks, Inc., Tokyo-to (JP)

(72) Inventors: Yuta TSUBOI, Tokyo-to (JP); Yuya UNNO, Tokyo-to (JP); Jun HATORI, Tokyo-to (JP); Sosuke KOBAYASHI, Tokyo-to (JP); Yuta KIKUCHI, Tokyo-to (JP)

(73) Assignee: Preferred Networks, Inc., Tokyo-to (JP)

(21) Appl. No.: 16/197,890

(22) Filed: Nov. 21, 2018

(30) Foreign Application Priority Data
Nov. 22, 2017 (JP) 2017-224708

(51) Int. Cl. G06T 11/60; G06F 17/24; G06T 3/60; G06T 11/00

(52) U.S. Cl. CPC G06T 11/60; G06T 11/001; G06T 3/60; G06F 17/24

(57) ABSTRACT

A data augmentation apparatus includes a memory and processing circuitry coupled to the memory. The processing circuitry is configured to input a first data set including first image data and first text data related to the first image data, perform first image processing on the first image data to obtain second image data, edit the first text data based on contents of the first image processing to obtain the edited first text data as second text data, and output an augmented data set including the second image data and the second text data.

### CROSS-REFERENCE TO RELATED APPLICATIONS

This application claims the benefit of and priority to Japanese Patent Application No. 2017-224708, filed on Nov. 22, 2017, the entire contents of which are incorporated herein by reference.

### FIELD

Embodiments described herein relate to a data augmentation apparatus, a data augmentation method, and a non-transitory computer readable medium.

### BACKGROUND

When machine learning is performed, over-fitting to training data may be suppressed by using augmented data subjected to transformation desired to preserve data. These methods are called data augmentation and are often used mainly in the field of image recognition or speech recognition. As transformation for securing universality, especially in the field of image recognition, extraction of an image and addition of flip or color noise may be performed.

In addition, as an application field of machine learning, research and development for picking up an object by recognizing an image and moving the object by specifying a relative position are widely performed. In the case of moving an object in this way, learning by using training data and text data may be performed on a positional relationship of the object. However, with a conventional data augmentation method, it is difficult to naturally augment data so that there is no contradiction in both what is reflected on an image and text data.

### BRIEF DESCRIPTION OF THE DRAWINGS

FIG. 1 is a block diagram showing functions of a data augmentation apparatus according to some embodiments;

FIG. 2 shows an example of an input data set;

FIG. 3 is a block diagram showing functions of a text editor according to some embodiments;

FIG. 4 is a flowchart showing data augmentation processing according to some embodiments;

FIG. 5 shows an example of an augmented data set according to some embodiments;

FIG. 6A and FIG. 6B show examples of correspondence between processing contents and replacement contents according to some embodiments;

FIG. 7 shows an example of an augmented data set according to some embodiments;

FIG. 8 shows an example of an augmented data set according to some embodiments;

FIG. 9A and FIG. 9B show examples of an input data set and an augmented data set respectively according to some embodiments;

FIG. 10A and FIG. 10B show examples of an input data set and an augmented data set respectively according to some embodiments;

FIG. 11 shows an example of correspondence between processing contents and replacement contents according to some embodiments;

FIG. 12A and FIG. 12B are block diagrams showing functions of a data augmentation apparatus according to some embodiments; and

FIG. 13 is a flowchart showing data augmentation processing according to some embodiments.

### DETAILED DESCRIPTION

According to some embodiments, a data augmentation apparatus may include a memory and processing circuitry coupled to the memory. The processing circuitry may be configured to input a data set including image data and text data related to the image data, perform image processing on the image data, edit the text data based on contents of the image processing, and output an augmented data set including the image data subjected to the image processing and the edited text data.

### First Embodiment

In the first embodiment, when image processing for augmenting a data set including image data and text data is performed, the text data may be edited as a natural language so as not to contradict conversion of the image in accordance with contents of the image processing, and the image data and the text data after the image processing may be intended to be output as an augmented data set.

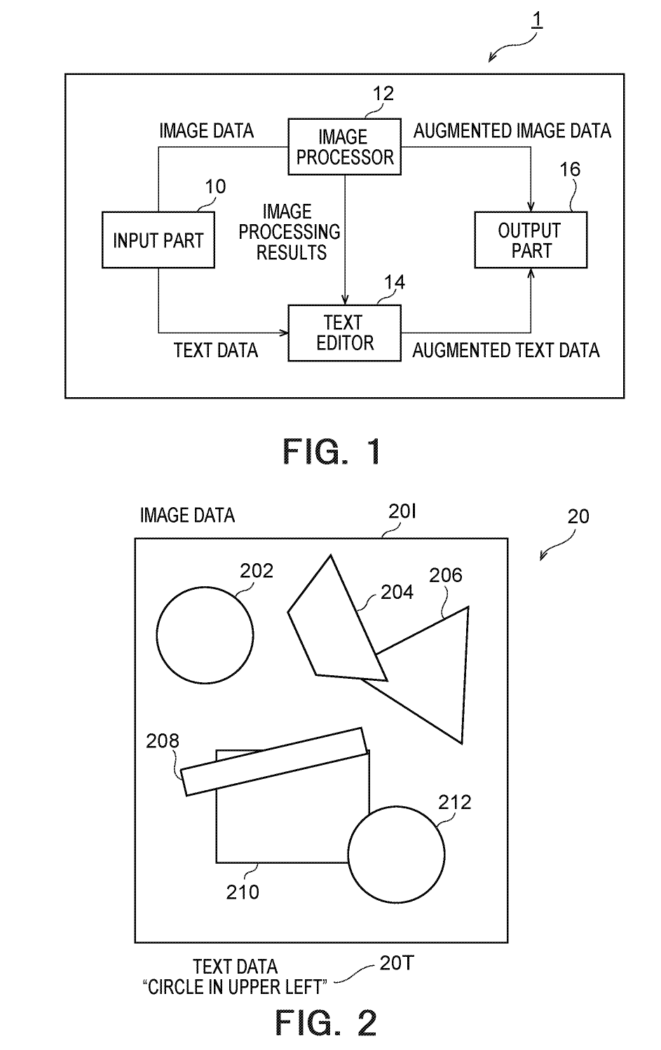

FIG. 1 is a block diagram showing functions of a data augmentation apparatus 1 according to the first embodiment. The data augmentation apparatus 1 may include an input part 10, an image processor 12, a text editor 14, and an output part 16.

The input part 10 may be an interface for receiving data input from outside. For example, the input part 10 is a graphical user interface (GUI) for receiving data input from the user. In the first embodiment, the input part 10 may input a data set including image data and text data on the contents related to the image data. At least one or more of the input part 10, the image processor 12, the text editor 14, and the output part 16 may be implemented with a special circuit (e.g., circuitry of a FPGA or the like), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like.

FIG. 2 is a diagram showing image data and text data of a data set to be input. A data set 20 includes image data 201 and text data 20T. The image data 201 may be, for example, a photograph, in which objects 202, 204, 206, 208, 210, . . . , 212 are photographed. The text data 20T is a text related to the contents of the image data 201, and may be, for example, data such as “circle in upper left” of the object 202.

The image processor 12 may receive the image data 201 from the input part 10 and perform image processing of the image data 201. Contents of the image processing may include, for example, a process of rotating, vertically inverting, or horizontally inverting a part of or all of the image data 201, or a process of changing the color of a part of or all of the image data 201.

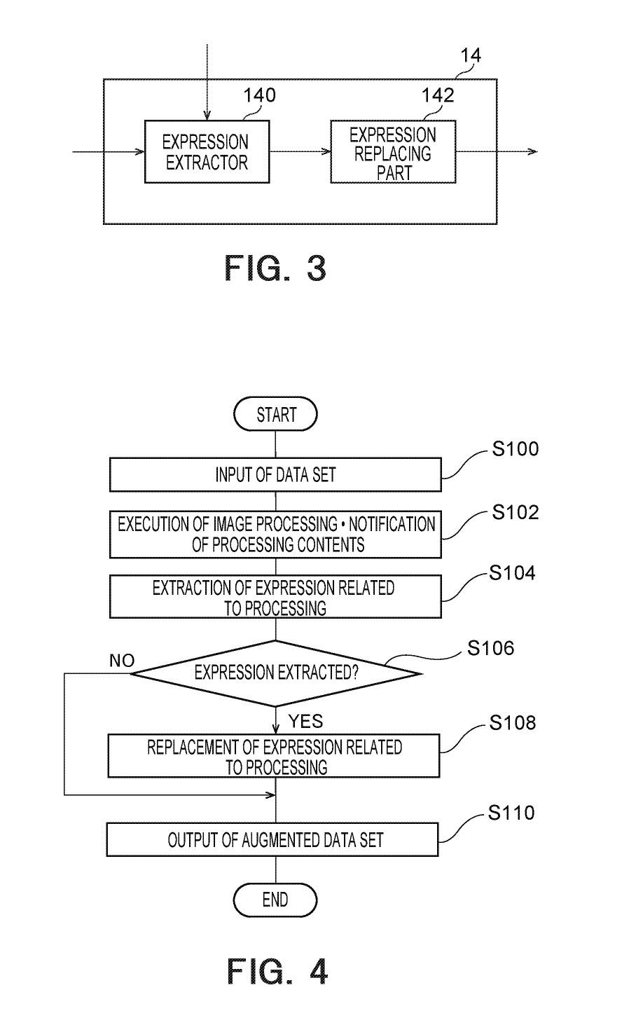

The text editor 14 may edit the text data 20T so as to conform to the image processing executed by the image processor 12. FIG. 3 is a block diagram showing functions of the text editor 14. The text editor 14 includes an expression extractor 140 and an expression replacing part 142.

The expression extractor 140 may receive the text data 20T (see FIG. 2) from the input part 10, receive processing contents of the image processing from the image processor 12, and extract an expression related to the image processing from the text data 20T. For example, when the image processor 12 performs a process of changing the positional relationship, such as rotating and inverting the image, a word, a phrase, or the like related to the position may be extracted. In the text data 20T shown in FIG. 2, the word “upper left” or the phrase “in the upper left” may be extracted. Regarding the extraction method, usual algorithms such as the Knuth-Morris-Pratt (KMP) method and the block maxima (BM) method may be used, or another so-called text mining method may be used.

The expression replacing part 142 may receive the expression extracted from the expression extractor 140 and the processing contents of the image processing from the image processor 12 and replaces the extracted expression related to the image processing according to the contents of the image processing. For example, when the extracted data is “upper left” and the image processing is processing of rotating the image to the right by 90 degrees, the word “upper left” is replaced with “upper right”.

Note that, for the configuration of the image processor 12 and the text editor 14, although it has been described that the image processor 12 determines the processing contents and notifies the text editor 14 of the processing contents, the present disclosure is not limited to this. For example, the data augmentation apparatus 1 may include an image processing content determiner (not shown) and notify the image processor 12 and the text editor 14 of the determined contents of the image processing. The image processing content determiner may be implemented with a special circuit (e.g., circuitry of a FPGA or the like), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like. Conversely to the above, the image processing contents may be determined from the expression extracted by the text editor 14 and notified to the image processor 12. As still another example, the processing contents may also be input as a data set via the input part 10, or the image processing contents may be input together with the data set, and the input part 10 may notify the image processor 12 and the text editor 14 of the processing contents, respectively.

Returning to FIG. 1, the output part 16 may receive, from the image processor 12, augmented image data which is input image data subjected to image processing. The output part 16 may receive, from the text editor 14, augmented text data which is input text data subjected to text editing, and output these data to the outside as an augmented data set.

FIG. 4 is a flowchart showing the processing flow of the data augmentation apparatus 1 according to the first embodiment. With reference to FIG. 4, detailed processing of the data augmentation apparatus 1 will be described.

First, a data set may be input through the input part 10 (step S100). The input part 10 to which the data set has been input may extract the image data and the text data from the data set, and output the image data to the image processor 12 and the text data to the text editor 14. Since the first embodiment is used, for example, for data augmentation as a preliminary preparation for machine learning, the amount of the data set may also be enormous. In such a case, the data set may be sequentially acquired by a script or the like and automatically input to the input part 10.

Next, the image processor 12 may execute the image processing on the image data to generate the augmented image data, and notify the text editor 14 of the executed processing contents (step S102). As an example, image processing will be described below as processing for converting the position of image data. To convert the position of the image data means, for example, a process of rotation of the whole image by an integral multiple of 90 degrees, vertical inversion, horizontal inversion, or a combination thereof.

The image processor 12 may perform at least one image processing by freely combining them, or may perform predetermined image processing. In the case of determining in advance, it is also possible for the user to designate the conversion used for data augmentation via the input part 10.

That is, for one input data set, the number of augmented data sets is not limited to one, and a plurality of augmented data sets may be output. The image processor 12 may notify the text editor 14 of the processing to be executed.

It does not matter which of these timings of execution and notification is earlier. That is, the processing contents may be notified after the image processing is executed, or the image processing may be executed after the processing contents are notified. Furthermore, the image processor 12 may include therein a processing content determiner, a processing content notifier, and a process executing part, which are not shown, and each of which may select, determine, notify, and execute the processing contents. At least one or more of the processing content determiner, the processing content notifier, and the process executing part may be implemented with a special circuit (e.g., circuitry of a FPGA or the like), a subroutine in a program stored in memory (e.g., EPROM, EEPROM, SDRAM, and flash memory devices, CD ROM, DVD-ROM, or Blu-Ray® discs and the like) and executable by a processor (e.g., CPU, GPU and the like), or the like.

Next, the expression extractor 140 of the text editor 14, which has been notified of the processing contents from the image processor 12, may extract an expression related to the image processing contents (step S104). Since the processing related to the position is being executed or to be executed as the image processing contents, the expression extractor 140 may extract information on the position from the text data, in particular, information on the relative position. In the example of FIG. 2, a text such as “upper left” or “in upper left” may be extracted from the text data “circle in upper left.”

Next, the expression extractor 140 may determine whether or not an expression has been extracted in step S104 (step S106).

When an expression has been extracted (step S106: YES), the expression replacing part 142 may replace the expression related to the image extracted by the expression extractor 140 according to a predetermined rule (e.g., the rule indicated by the tables of FIG. 6A and FIG. 6B) based on the image processing contents notified from the image processor 12 (step S108). For example, in FIG. 2, when the content of the image processing is the rotation of the whole image by 90 degrees to the right, the extracted expression of “upper left” (“in the upper left”) may be replaced with “upper right” (“in the upper right”) to generate augmented text data. Such a replacement rule may be stored in the expression replacing part 142 or the data augmentation apparatus 1 may include an expression replacement database (not shown) and the replacement rule may be stored in the expression replacement database.

Next, the output part 16 may output an augmented data set including augmented image data generated by the image processor 12 and augmented text data generated by the text editor 14 (step S110).

When no expression is extracted (step S106: NO), the output part 16 may output the input text data in which the expression is not replaced, as augmented text data. Alternatively, a flag indicating that the expression was not extracted may be set and the augmented data set may be attached with the flag and output. By attachment of a flag, the user may be prompted not to use the flagged augmented data set or to reconfirm the flagged augmented data set.

In the above description, since the image processing is image processing on the position, in this case, the expression extractor 140 may be a position expression extractor, and the expression replacing part 142 may be a position expression replacing part. However, embodiments of the present disclosure are not limited thereto. The expression or 140 may be a color expression extractor, and the expression replacing part 142 may be a color expression replacing part.

### Concrete Example of Conversion

A concrete example of conversion will be described below.

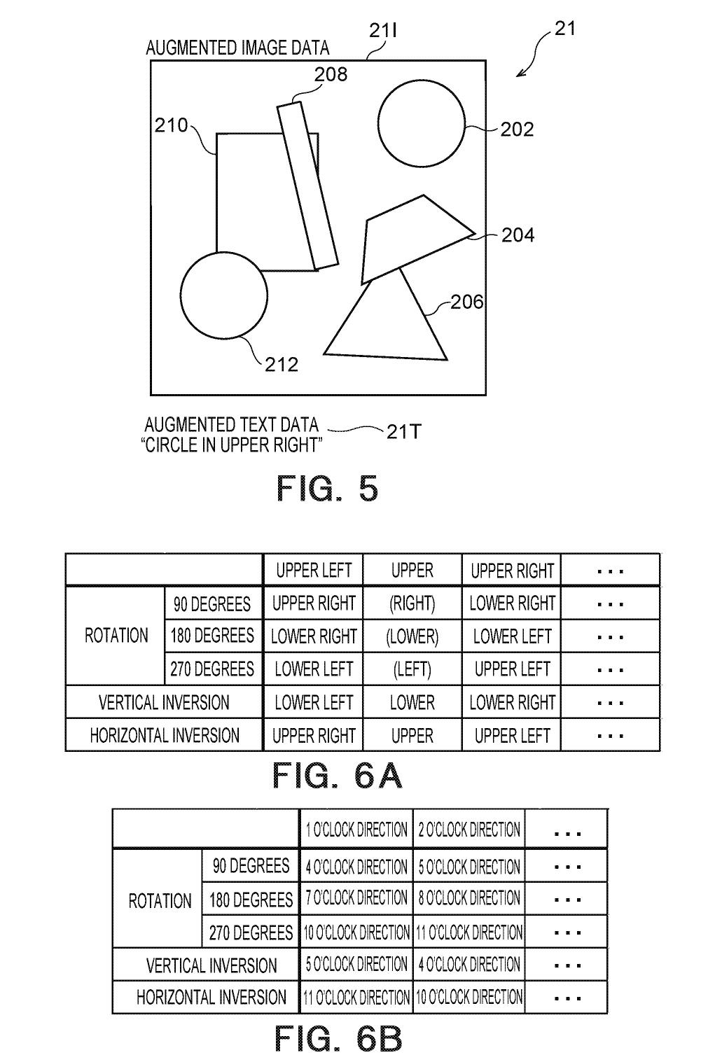

First, an augmented data set in the case of performing image processing on the position of the data set shown in FIG. 2 will be described. FIG. 5 is a diagram showing an example of generation of an augmented data set 21 in the case of performing image processing on the image data 201 of the input data set 20 to rotate it to the right by 90 degrees.

When the whole image is rotated to the right by 90 degrees with respect to the input data set 20, the image data 201 may be converted like augmented image data 211. Image processing may be executed by a general method. In some embodiments, this conversion may be to convert the relative positional relation of the whole image with respect to an existing region of the image. Then, the expression extractor 140 may determine to edit the text data related to the position based on this information of 90-degree right rotation received from the image processor 12.

Since the input text data 20T is “circle in upper left” (see FIG. 2), the expression extractor 140 (position expression extractor) extracts the word “upper left” or the phrase “in the upper left”, which is information related to the position, from the text data 20T. Hereinafter, words are extracted unless otherwise stated.

FIG. 6A is a correspondence table for replacing such words related to positions. The expression replacing part 142 (e.g., position expression replacing part) may store such a table as a database. Also, it is not always necessary to be in the form of a table, and it may be separately stored in association with each state of position or each processing content. Note that, as to the rotation, the case of rotating clockwise is shown in FIG. 6A and FIG. 6B, but it is not limited to this case. Although only the cases of upper left, upper, and upper right are shown in the table, it is not limited to this, and it contains other data.

In addition, referring to FIG. 6A, parentheses may be added to a word replacing the word “upper” in the case of performing rotation, so that the parentheses indicate that a replacing word is not always uniquely determined. When a replacing word is not uniquely determined, the user may allow or disallow such replacement. Alternatively, the image processor 12 may notify the text editor 14 that, for example, images in the region near the upper middle are converted to those that are not in an upper position but the other images are not converted.

According to the replacement described in FIG. 6A, the expression replacing part 142 may acquire the expression “upper right” as the expression corresponding to “upper left” when the amount of the rotation is 90 degrees. Then, the extracted word “upper left” may be replaced with the word “upper right”, and the text data “circle in upper right” may be generated as augmented text data 21T.

The output part 16 may output the data set including the augmented image data 211 and the augmented text data 21T to the outside as an augmented data set 21.

Note that, the correspondence relationship between the image data and the text data is not necessarily one to one. For example, when the object 206 is also learned in addition to the object 202, “triangle in the upper right” may be set for the same image data 201 as second text data. Then, conversion is made in the same way as above, and “triangle in the lower right” is generated as second augmented text data. In this case, the output part 16 may output the generated augmented image data 211 and the second augmented text data as second augmented data set.

As another example of output, the augmented text data 21T and the second augmented text data may be together set as the augmented image data 211, and a data set in which a plurality of pieces of text data are associated with one image may be output as the augmented data set 21.

As still another example, the augmented image data 211 itself is not included in the second augmented data set including the second augmented text data, and association relationship with the augmented image data 211 in the augmented data set 21 may be included in the second augmented data set to reduce the data storage capacity.

The table of FIG. 6B shows another example showing a relative position expression. In this way, a replacing word corresponding to expressions other than upper, lower, left, and right may be determined. For example, as shown in FIG. 6B, also in the case of using other expressions, such as expression of the relative position using a clock, as another example such as expression of the relative position using the directions of east, west, north and south, it is possible to perform extraction of expressions and replacement of expressions by preparing a correspondence table in advance.

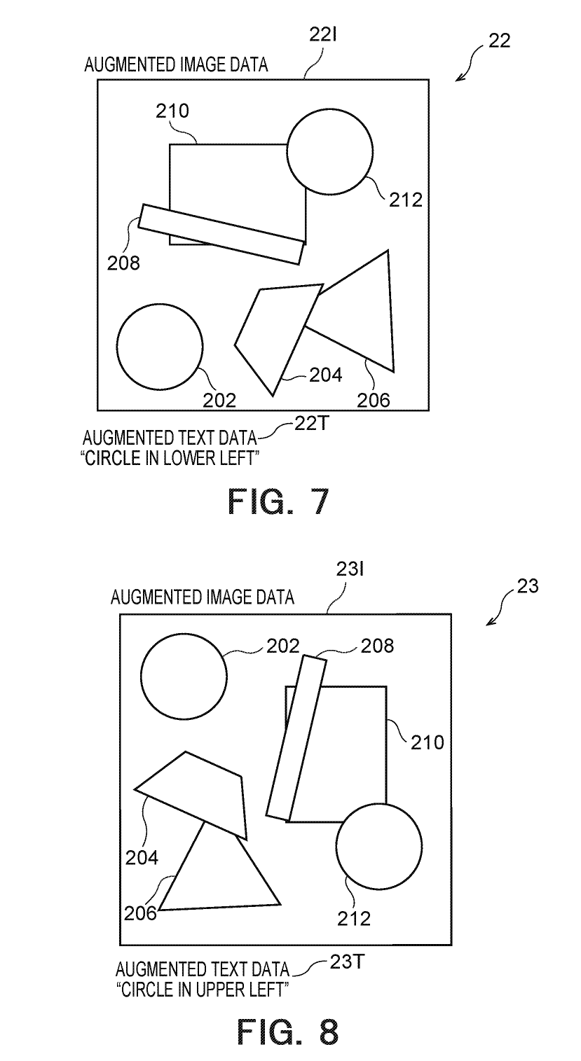

FIG. 7 is a diagram showing an augmented data set 22 in the case of performing image processing of another example. In FIG. 7, the image processing is the vertical inverting processing of the whole image. In the augmented image data 221, the object 202 is positioned at the vertically inverted position, that is, in the lower left. Since the text data 20T is “circle in upper left”, similarly to the above, “upper left” may be extracted first. Then, according to the correspondence table shown in FIG. 6A, “upper left” may be replaced with “lower left” which is a “vertical inverting” expression of “upper left”, to generate augmented text data 22T of “circle in lower left”.

These image processing of changing positions may be used in combination. In FIG. 8, augmented image data of an augmented data set 23 may be generated by combining image processing of changing positions of the whole image. Augmented image data 231 may be obtained by rotating the image data 201 to the right by 90 degrees and then horizontally inverting the resultant image data. As another expression, it may be obtained by rotating the image data 201 to the left by 90 degrees and then vertically inverting the resultant image data. Here, it is thought that after rotation to the right by 90 degrees, the resultant image data is horizontally inverted to obtain the augmented image data 231 in FIG. 8.

First, similarly to the above, the expression extractor 140 may extract “upper left” as a position expression. According to the correspondence table of FIG. 6A, because the image data is rotated to the right by 90 degrees, the expression of “upper left” may be replaced with the expression of “upper right”. Subsequently, because the image data is horizontally inverted, the expression of “upper right” may be replaced with the expression of “upper left”. Resultant augmented text data 23T may be “circle in upper left”.

Note that, in the image processing of generating the augmented image data in FIG. 8, in the case where the image region is a square, the whole image may be inverted with respect to a diagonal line extending from the upper left to the lower right. In the case where the image region is not a square, the whole image may be inverted with respect to a straight line at 45 degrees passing through a predetermined point (a point in the upper left of the image, a central point, or the like). Even for such transformation, a correspondence table may be prepared, and the expression may be replaced according to the correspondence table.

Such a combination can be further generalized. Such image conversion can be expressed by setting a center point and then performing a linear transformation centered on that point. As to a matrix of the linear transformation, for example, in the case where the matrix representing the vertical inversion is Tv, the matrix representing the horizontal inversion is Th, and the matrix representing the rotational conversion in the θ degree clockwise direction is R (θ), the conversion as described above can be expressed as, or decomposed into, a combination of Tv (=[[1 0] [0 −1]]), Th (=[[− 1 0] [0 1]]) and R (θ) (=[[cos (θ°) sin θ°)] [−sin (θ°) cos (θ°)]].

After the decomposition into such a combination, the extracted expression may be replaced in the order of the conversion matrixes appearing in the matrix product representing the combination, according to the correspondence table. That is, even if the image processing itself is not described in the order of each conversion, when the conversion can be expressed by a finite number of products of above -described Tv, Th and R (θ), the text data can be replaced according to this conversion expressed by the products. The text editor 14 may include a matrix computing part that performs a matrix computation for decomposing such a matrix subjected to image processing into the above conversion matrixes. Then, based on the result of decomposition of the matrix computing part, the expression replacing part 142 may replace the expression.

Not limited only to the above, for example, a correspondence table augmented for an affine transformation that performs parallel translation before and after using the above conversion matrix may be prepared so as to correspond to such affine transformation.

Note that the rotation is not limited to the 90-degree unit. It is also possible to prepare a correspondence table in which FIG. 6B is augmented so that the granularity of rotation is set to 30-degree unit. For example, the item of the rotation position in FIG. 6B may be changed for every 30 degrees, and the correspondence table may be set finer such that 30 degrees for the 1 o'clock direction: 60 degrees for the 2 o'clock direction: . . . the 3 o'clock direction: . . . . Such a correspondence table may be prepared in advance, and thereby it is possible to change the position expression even for conversion for every 30 degrees. As another example, when it is expressed in the direction of east, west, north and south as described above, it is also possible to correspond to rotation in units of 45 degrees or 22.5 degrees.

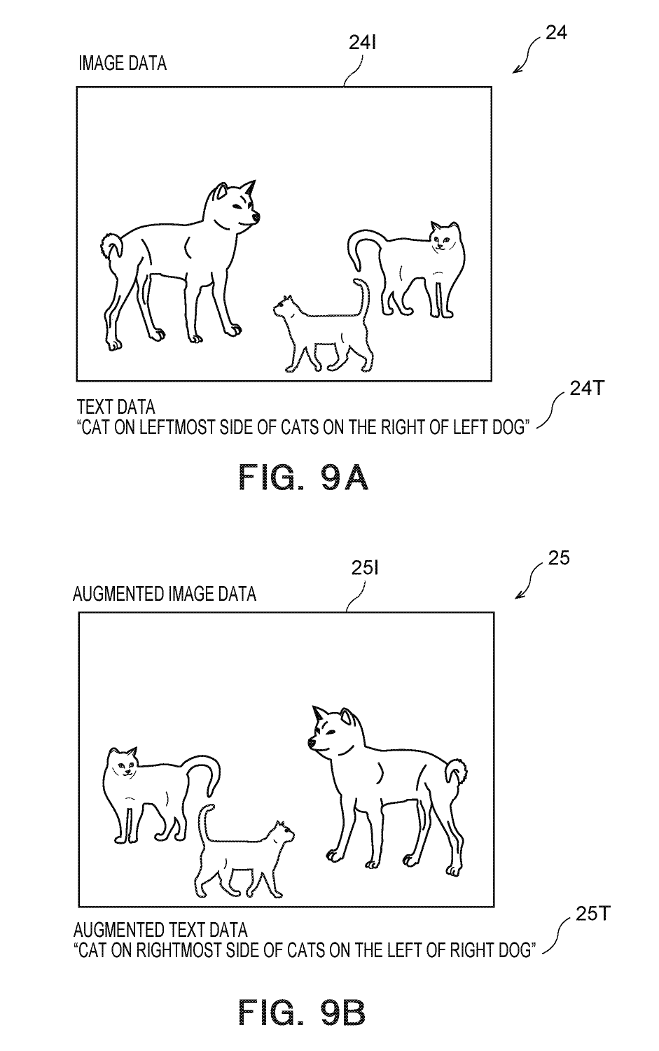

In the above example, the states of viewing a place where the objects are lined up from the sky are shown, but it is not limited to these. FIGS. 9A and 9B are examples of an image that is not vertically inverted in general.

FIG. 9A is a diagram showing a data set 24 to be input, and FIG. 9B shows an augmented data set 25 to be output. Image data 24I is an image in which animals are photographed, and generally is not subjected to vertical inversion or rotation operation. When data augmentation is performed on such an image, for example, data augmentation by horizontal inversion may be performed. In such a case, the user may be able to specify image processing to be performed via the input part 10.

As the image processing, the horizontal inversion processing may be performed, and an image that is horizontally inverted is generated as augmented image data 25I. As shown in FIG. 9A, text data 24T is “cat on the leftmost side of the cats on the right of the left dog”. The expression extractor 140 sequentially extracts expressions “left”, “right”, and “left”. Then, the expression replacing part 142 may replace the respective expressions with “right”, “left”, “right”, and text data of “cat on the rightmost side of the cats on the left of the right dog” is generated as augmented text data 25T. In this way, when there are multiple expressions, replacement may be made for each expression.

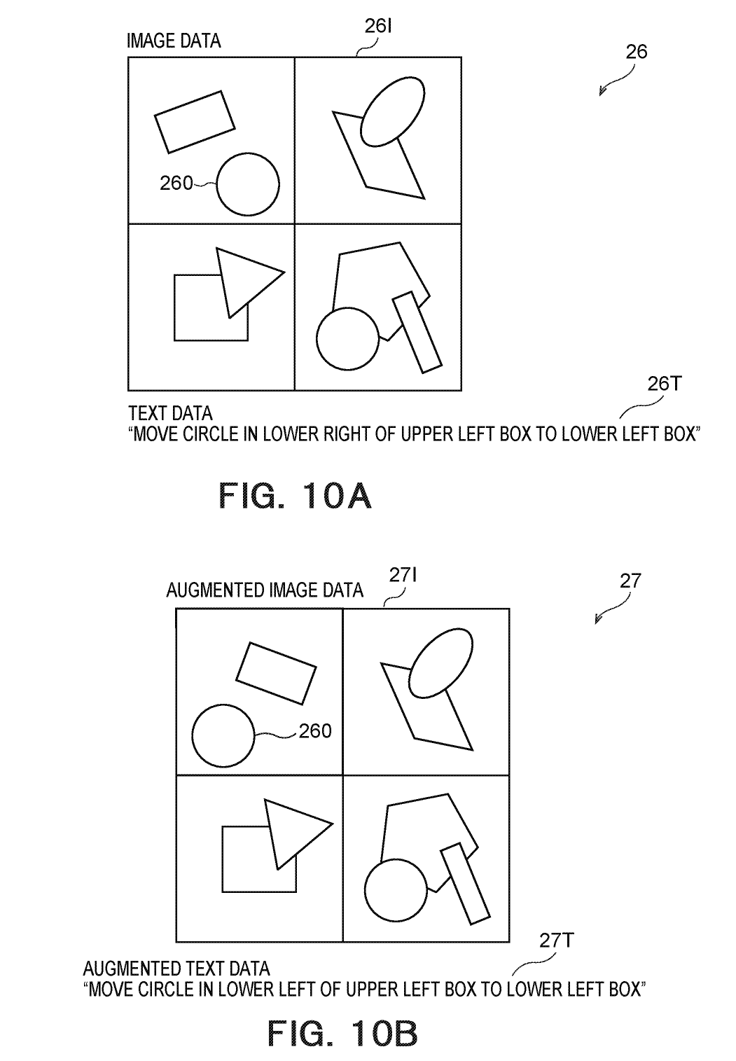

In the concrete example described above, the example of processing the whole image has been described, but a part of the image may be processed. FIGS. 10A and 10B are diagrams showing an example of generating an augmented data set when processing a part of an image.

In image data 26I of an input data set 26 shown in FIG. 10A, the region is divided into four boxes, and objects are placed in the respective regions. For this image data 26I, it is assumed that text data 26T is “move circle in lower right of upper left box to lower left box”. In this state, if the whole image is horizontally inverted, the augmented text data would be “move circle in lower left of upper right box to lower right box”.

Referring to FIGS. 10A and 10B, from the image data 26I, an augmented image data 27I of an augmented data set 27 may be generated by horizontally inverting the image of only the upper left box (e.g., the image of the object 260). When the image processor 12 converts a part of such an image, the text editor 14 having received such a notification may determine that only the upper left box has been image-converted, extract the expression related to the upper left box, and replace it.

More specifically, position expressions subsequent to, or following, such words as “upper left box”, “upper left region”, or “box (upper left)” may be extracted. At this time, the position expression following the “upper left box” may be extracted so as not to extract the position expression related to the position of the box, such as “upper left box”, “upper right box”, “lower left box”, or “lower right box”.

When extraction of expressions is performed as described above, “lower right” of “circle in lower right” may be extracted, while expressions are extracted so that the expressions related to the location of a box, such as “upper left”, “lower left” of “upper left box”, “lower left box”, are not extracted. Thereafter, similarly to the case described above, the extracted expression of “lower right” may be replaced with “lower left” according to the correspondence table of FIG. 6A to generate augmented text data 27T.

Of course, whole and partial conversions may be combined. The box in the upper left may be horizontally inverted and the whole may be vertically inverted. In this case, the augmented text data is “move circle in upper left in lower left box to upper left box”. Such a conversion may be executed so that first the partial conversion processing is performed so as not to extract the position information related to the position of the box, and then the entire position information including the position information related to the position of the box is converted. In this way, it is also possible to deal with various conversion processing related to position. Processing can be performed in the same way also when rotation processing is included.

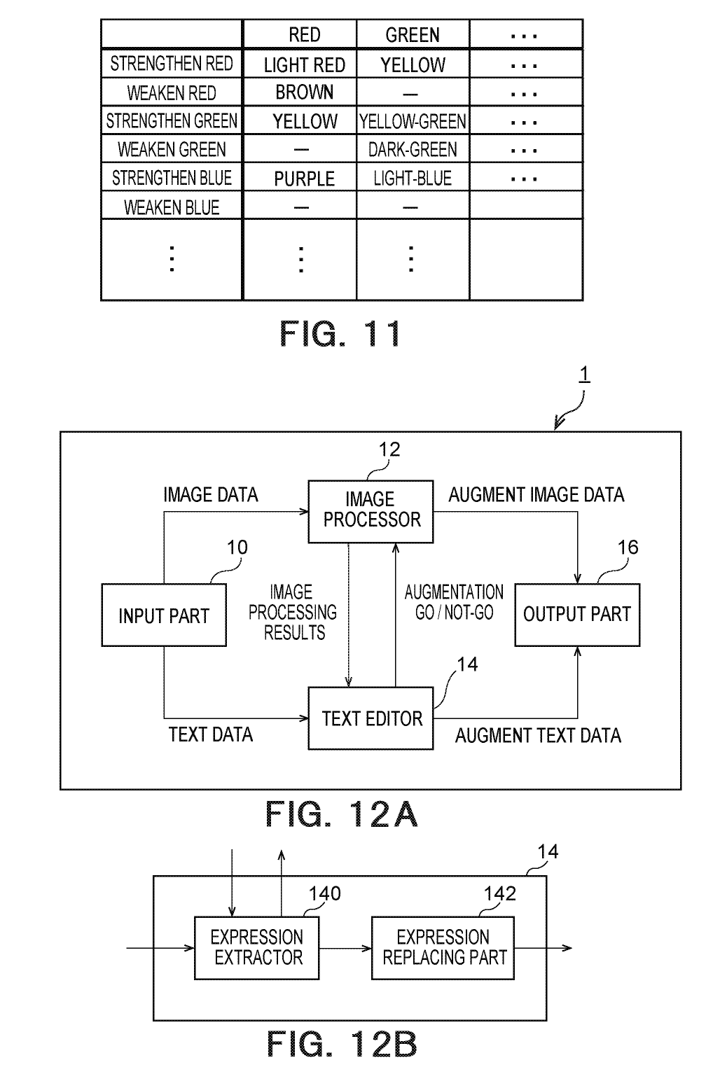

In the above description, the position expression of the text data has been described, but the expression text may be related to the color. FIG. 11 shows a part of a correspondence table of expressions related to colors. When extracting a color expression, the expression extractor 140 may be a color expression extractor, and the expression replacing part 142 may be a color expression replacing part.

In FIG. 11, for example, when processing such as strengthening a red color as image processing is performed on a green object, it means that the expression is changed to a yellow color. Further, image processing, such as changing a red color to a blue color instead of designation, strengthening a red color, or image processing, performing color inversion processing, may be performed. The example shown in FIG. 11 is merely an example, and it is only necessary to prepare a correspondence table that can replace expressions as color conversion. For example, by preparing a similar correspondence table also for image processing of converting color temperature or converting saturation and brightness, it is also possible to apply the correspondence table to these conversions.

The extraction and replacement of the color expression can be performed in the same manner as in the case of the position described above. It may be color conversion for the whole image or color conversion for a part of the image as in the example shown in FIGS. 10A and 10B. In addition, it is possible to extract and replace expressions even in such image processing as converting only a predetermined color region.

Further, in the above description, the position and the color are separately determined, but the present disclosure is not limited to this. It is also possible to generate the augmented image data by performing image processing including both the position and the color, and generate the augmented text data based on the image processing. For example, text data, such as “a red circle in the upper left”, may be input.

As described above, according to the first embodiment, for example, when it is desired to augment data used for learning, that is, when so-called data augmentation is desired to be performed, it is possible to perform natural conversion of text data on a data set in which an image and a text become a set, without inconsistency to the image processing contents made to the image data. By performing conversion in this manner, it is possible to suppress overfitting and provide accurate training data with respect to a data set including image data and text data in association with each other, and to improve accuracy in machine learning.

### Second Embodiment

In the first embodiment described above, image processing may be performed even when expressions cannot be extracted. However, when image data and text data become a set, meaning of generating a data set may not be so meaningful if augmented text data is not generated. In the second embodiment, in such a case, the data set is not generated.

FIG. 12A is a block diagram of the data augmentation apparatus 1 describing a data flow according to the second embodiment. The difference from FIG. 1 is that not only the image processing contents are notified from the image processor 12 to the text editor 14, but also the determination result of whether or not to perform the image processing is notified from the text editor 14 to the image processor 12 (as indicated by the arrow from the text editor 14 to the image processor 12 in FIG. 12A).

This determination of whether or not to perform the image processing may be performed based on whether or not the expression extractor 140 of the text editor 14 has extracted the expression related to image processing. As another example, when the expression has been extracted but it is difficult to replace the expression uniquely, it may be determined not to perform image processing.

In some cases, it is difficult to replace the expression uniquely. For example, in the case of image processing such as rotating to the right by 30 degrees, even if there is an expression of the position of upper left, depending on the position of an object in the upper left direction, even after the object rotates by 30 degrees, it may be in the upper left, or it may move to the upper right by the 30 degree-rotation. In such a case, augmented data may not be generated assuming that it is difficult to uniquely replace the expression. Also for color expression, for example, when there is a color conversion or the like not described in the correspondence table, it can be determined that it is difficult to uniquely replace the expression.

In addition, another example is a case where the text data of the input data set is an expression such as “first circular object”. In many cases, it can be understood that it is a circle in the upper left, but for example, if this image is vertically and horizontally inverted, it is unknown which position to move depending on the number and positions of circular objects. In such a case, it may be determined not to generate the augmented data set.

FIG. 12B is a block diagram of the text editor 14. In this way, the expression extractor 140 may receive the image processing contents from the image processor 12 and notify the image processor 12 of the image processing possibility determination (as indicated by the arrow from the expression extractor 140 to the image processor 12 in FIG. 12B).

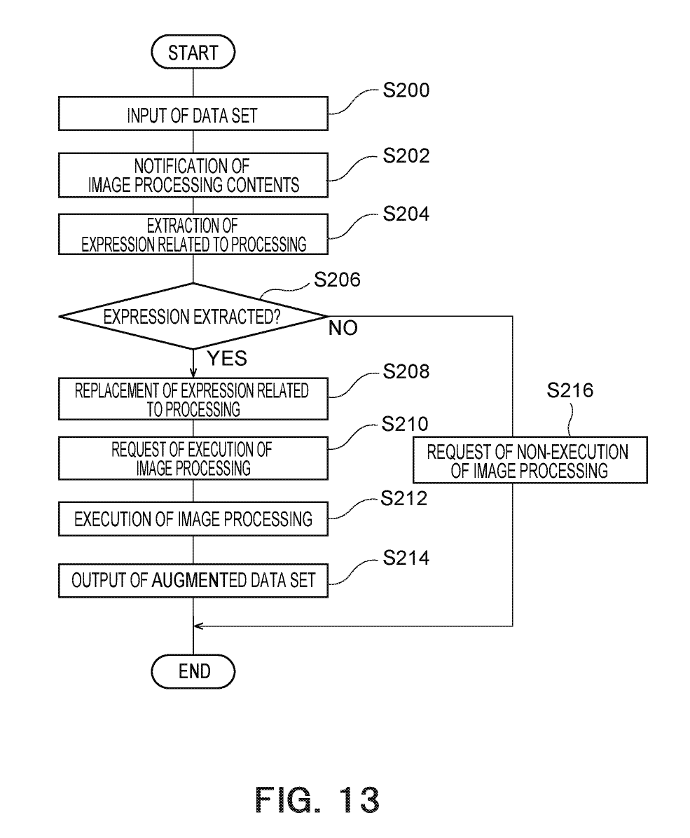

FIG. 13 is a flowchart showing processing according to the second embodiment. The processing flow will be described with reference to FIG. 13.

First, the input part 10 may receive an input of a data set (step S200). This processing may be the same as step S100 shown in FIG. 4.

Next, the image processor 12 may notify the image processing contents to the expression extractor 140 of the text editor 14 (step S202). In some embodiments, at this timing, the image processor 12 does not have to execute image processing.

Next, the expression extractor 140 may extract an expression related to processing (step S204). This processing may be the same as step S104 shown in FIG. 4.

Next, the expression extractor 140 may determine whether or not an expression related to the processing has been extracted (step S206). When it is determined that the expression has been extracted (step S206: YES), replacement of the expression related to the processing may be performed (step S208).

Next, the expression extractor 140 may request the image processor 12 to execute image processing (step S210). Upon receiving this request, the image processor 12 may execute image processing (step S212). The subsequent flow is the same as the flow of steps S108 and S110 in FIG. 4. For example, the output part 16 may output an augmented data set including augmented image data generated by the image processor 12 and augmented text data generated by the text editor 14 (step S214). Note that the order of steps S208 and S210 can be interchanged. For example, by interchanging them, it is also possible to perform replacement of the expression related to the processing by the expression replacing part 142 and execution of the image processing by the image processor 12 in parallel.

On the other hand, when it is determined that the expression related to the processing has not been extracted (step S206: NO), the expression extractor 140 may make a request not to execute image processing (step S216). Upon receiving this request, the image processor 12 may terminate the processing without performing image processing. Likewise, the text editor 14 also may terminate the processing.

As described above, according to the second embodiment as well, it is possible to generate an augmented data set for the input data set as in the first embodiment, and it is possible to terminate the processing without performing the image processing and not to generate the augmented data set if the augmented text data cannot be generated depending on the image processing contents. By doing in this way it is possible to suppress generation of a data set invalid in the generated augmented data set, for example, a data set that cannot be used for learning.

Note that, completion of each processing may be notified to other parts of the data augmentation apparatus 1. By doing this, it is possible to prevent the processing from stacking. In addition, as another example, when a plurality of data sets are input, these data sets may be placed in a queue and dequeued at the timing when the image processor 12 and the text editor 14 terminate the processing.

### Modified Example of Data Set Generation

In the case of using a 3D simulator, 3D Computer Aided Design (CAD), or the like in the generation of a data set, this CAD information may be included in the data set in the image data. By use of the information on CAD or the like, for example, if the color expression or the like is represented by RGB numerical values by these pieces of information, it becomes possible to more accurately extract and replace also expressions related to colors. In this case, it is also possible to perform image processing to convert the shape of an object, and it is also possible to create augmented data in a wider range.

As another example, a data set may be generated using a method of generating text data from image data based on models learned in other fields. In this case, it is also possible to automatically generate and use an augmented data set as a data set to become training data for an image of an augmented target field.

In this way, it is also possible to generate an augmented data set including the data set used in generating the augmented data set itself.

In each of the above-described embodiments, when the image is not a square, the image may sometimes protrude in the horizontal direction or the vertical direction by performing the 90-degree rotation, but various methods are considered for the correction method of the protruding portion. As a simple method, the entire region of the image may be rotated by interchanging the vertical and horizontal sizes of the image with rotation.

When the region of the image is decided, the processing may be performed as follows. For example, when an object of interest is in a region where the object protrudes by being subjected to image processing, rotation may be performed after parallel translation so that the object of interest does not protrude even if image processing is performed. As an alternative method, the image may be compressed into a square. On the other hand, when the region outside the image enters the image region by rotation, for example, zero padding may be performed, or interpolation may be performed using information of the edge portion of the image.

The data to be exchanged does not necessarily have to be stored in natural language (e.g., English or Japanese) as in the description of the drawing or the above embodiments, and for example, the data may be converted into a numerical value and stored in a database or the like. Also, regarding the notification between the respective constituent elements, flags and the like may be represented by numerical values and transmitted and received.

Although the language to be used is explained as being English or Japanese, it is not limited to this but it can be applied to other languages such as English.

Although the input/output data is explained as being a data set including image data and text data, it is not limited to this. As long as the correspondence relationship between image data and text data can be adequately secured, for example, the image data and the text data may be separately input and processed, and the processed augmented image data and augmented text data may be separately output. As an example, there may be an image database and a text database, from which image data and text data may be individually input and into which image data and text data may be individually output. In this way, input and output are not necessarily data sets.

All of the embodiments and concrete examples described above can be applied, for example, to a case where when work by an industrial robot is performed, an instruction may be given by a human voice. An augmented data set may be generated in advance by the data augmentation apparatus 1 according to some embodiments and a data set including this augmented data set may be learned as training data and a model is generated. Generating a model in this way may allow the robot to perform more flexible handling via the model.

However, the application range is not limited to robots, but it can be applied, for example, to data sets of image data and text data requiring information on position or color. As an example, automatic generation of a text describing the contents of image data can be cited, but it is not limited to this and it can be applied to a wide range of fields.

Note that, in the above description, a circular object is used, but this circular object is of course an example, and for example, can juice or the like may be used. For other objects also, concrete objects are assumed to be photographed in the image.

In the above-described entire description, at least a part of the data augmentation apparatus 1 may be configured by hardware, or may be configured by software and a CPU and the like perform the operation based on information processing of the software. When it is configured by the software, a program which achieves the data augmentation apparatus 1 and at least a partial function thereof may be stored in a storage medium such as a flexible disk or a CD-ROM, and executed by making a computer read it. The storage medium is not limited to a detachable one such as a magnetic disk or an optical disk, but it may be a fixed-type storage medium such as a hard disk device or a memory. That is, the information processing by the software may be concretely implemented by using a hardware resource. Furthermore, the processing by the software may be implemented by the circuitry of a FPGA or the like and executed by the hardware. The generation of a learning model or processing after an input in the learning model may be performed by using, for example, an accelerator such as a GPU. Processing by the hardware and/or the software may be implemented by one or a plurality of processing circuitries representing CPU, GPU, and so on and executed by this processing circuitry. That is, the data augmentation apparatus 1 according to this embodiment may include a memory that stores necessary information of data, a program, and the like, one or more processing circuitry that execute a part or all of the above -described processing, and an interface for communicating with the exterior.

Further, the data inference model according to some embodiments can be used as a program module which is a part of artificial intelligence software. That is, the CPU of the computer operates so as to perform computation based on the model stored in the storage part and output the result.

The image inputted and/or outputted in the above -described embodiment may be a grayscale image or a color image. In the case of a color image, any color space, such as RGB or XYZ, may be used for its expression as long as colors can be properly expressed. In addition, the format of the input image data may be any format, such as raw data, a PNG format, or the like, as long as the image can be properly expressed.

A person skilled in the art may come up with addition, effects or various kinds of modifications of the present disclosure based on the above-described entire description, but examples of the present disclosure are not limited to the above-described individual embodiments. Various kinds of addition, changes and partial deletion can be made within a range that does not depart from the conceptual idea and the gist of the present disclosure derived from the contents stipulated in claims and equivalents thereof.

1. A data augmentation apparatus, comprising,
a memory, and
processing circuitry coupled to the memory,
wherein the processing circuitry is configured to:
input a first data set including first image data and first text data related to the image data;
perform first image processing on the first image data to obtain second image data;
edit the first text data based on contents of the first image processing to obtain the edited first text data as second text data; and
output a second data set including the second image data and the second text data.

2. The data augmentation apparatus according to claim 1, wherein the processing circuitry is further configured to:
extract an expression related to the first image processing from the first text data, and
replace the extracted expression based on the contents of the first image processing.

3. The data augmentation apparatus according to claim 2, wherein the processing circuitry is further configured to execute, as the first image processing, at least one of rotating, vertically inverting, or horizontally inverting at least a part of the first image data.

4. The data augmentation apparatus according to claim 3, wherein
the processing circuitry is further configured to:
extract the expression relating to a relative position in the first image data,
replace the extracted expression relating to a relative position based on the contents of the first image processing, and
edit the expression relating to a relative position in the first image data based on the contents of the first image processing.

5. The data augmentation apparatus according to claim 2, wherein the processing circuitry is further configured to execute, as the first image processing, a process of changing information on a color of at least a part of the first image data.

6. The data augmentation apparatus according to claim 5, wherein the processing circuitry is further configured to:
extract the expression relating to a color in the first image data,
replace the extracted color expression based on the contents of the first image processing, and
edit the expression relating to a color in the first image data based on the contents of the first image processing.

7. The data augmentation apparatus according to claim 2, wherein the processing circuitry is further configured:
to determine whether the first text data can be edited based on the contents of the first image processing; and
not to execute the first image processing when it is determined that the first text data cannot be edited based on the contents of the first image processing.

8. The data augmentation apparatus according to claim 7, wherein the processing circuitry is further configured to determine that it is not possible to edit the first text data when the expression related to the first image data cannot be extracted or when the expression cannot be replaced based on the contents of the first image processing.

9. A data augmentation method comprising:
inputting, by processing circuitry, a first data set including first image data and first text data related to the first image data;
performing, by the processing circuitry, first image processing on the first image data to obtain second image data;
editing, by the processing circuitry, the first text data based on contents of the first image processing to obtain the edited first text data as second text data; and
outputting, by the processing circuitry, an augmented data set including the second image data and the second text data.

10. The data augmentation method according to claim 9, further comprising:
extracting, by the processing circuitry, an expression related to the first image processing from the first text data; and
replacing, by the processing circuitry, the extracted expression related to the first image processing based on the contents of the first image processing.

11. The data augmentation method according to claim 10, further comprising:
executing, as the first image processing, at least one of rotating, vertically inverting, or horizontally inverting at least a part of the image data.

12. The data augmentation method according to claim 11, further comprising:
extracting, by the processing circuitry, the expression relating to a relative position in the first image data,
replacing, by the processing circuitry, the extracted expression relating to a relative position based on the contents of the first image processing, and
editing, by the processing circuitry, the expression relating to a relative position in the first image data based on the contents of the first image processing.

13. The data augmentation method according to claim 10, further comprising:
executing, by the processing circuitry as the first image processing, a process of changing information on a color of at least a part of the first image data.

14. The data augmentation method according to claim 10, further comprising:
determining, by the processing circuitry, whether the first text data can be edited based on the contents of the first image processing; and
not executing the first image processing when it is determined that the first text data cannot be edited based on the contents of the first image processing.

15. A non-transitory computer readable medium storing therein a program which, when executed by a processor of a computer performs a method comprising:
inputting a data set including first image data and first text data related to the first image data;
performing first image processing on the first image data to obtain second image data;
editing the first text data based on contents of the first image processing to obtain the edited first text data as second text data; and
outputting an augmented data set including the second image data and the second text data.

16. The non-transitory computer readable medium according to claim 15, wherein the method further comprises:
extracting an expression related to the first image processing from the first text data, and
replacing the extracted expression related to the first image processing based on the contents of the first image processing.

17. The non-transitory computer readable medium according to claim 16, wherein the method further comprises: executing, as the first image processing, at least one of rotating, vertically inverting, or horizontally inverting at least a part of the image data.

18. The non-transitory computer readable medium according to claim 17, wherein the method further comprises:
extracting the expression relating to a relative position in the first image data;
replacing the extracted expression relating to a relative position based on the contents of the first image processing; and
editing the expression relating to a relative position in the first image data based on the contents of the first image processing.

19. The non-transitory computer readable medium according to claim 16, wherein the method further comprises:
executing, as the first image processing, a process of changing information on a color of at least a part of the first image data.

20. The non-transitory computer readable medium according to claim 16, wherein the method further comprises:
determining whether the first text data can be edited based on the contents of the first image processing; and
not executing the first image processing when it is determined that the first text data cannot be edited based on the contents of the first image processing.
